(19) United States
(12) Patent Application Publication
(10) Pub. No.: US 2025/0348969 A1
(43) Pub. Date: Nov. 13, 2025

(54) DISTINCT VISIBLE EVENT TOKENS FOR DISTINCT EXECUTE COMMANDS AND VISIBLE DRAW CALL PRIMITIVES

(71) Applicant: QUALCOMM Incorporated, San Diego, CA (US)

(72) Inventors: Nigel POOLE, West Newton, MA (US); Richard HAMMERSTONE, Tyngsboro, MA (US); Srihari Babu ALLA, San Diego, CA (US)

(21) Appl. No.: 18/662,928

(22) Filed: May 13, 2024

(51) Int. Cl. G06T 1/20; G06F 9/30; G06F 9/38

(52) U.S. Cl. CPC G06T 1/20; G06F 9/30145; G06F 9/3802

(57) ABSTRACT

This disclosure provides systems, devices, apparatus, and methods, including computer programs encoded on storage media, for processing driver commands. A graphics processor may insert a driver command into a set of draw calls included in a binning pass. The driver command may be associated with a distinct visible event type. The graphics processor may insert, based on the driver command being associated with the distinct visible event type, a distinct visible token into a visibility stream. The graphics processor may decode the distinct visible token during a bin-render pass. The graphics processor may retrieve an entry from a table based on the distinct visible token, wherein the entry indicates a distinct execute command. The graphics processor may execute the distinct execute command after the retrieval of the entry.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address optimizing state-fetching during a bin-render pass. There is a need for improved state-fetching for different event types.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and at least one processor coupled to the memory. Based at least in part on information stored in the memory, the at least one processor may be configured to insert a driver command into a set of draw calls included in a binning pass, where the driver command is associated with a distinct visible event type. The at least one processor may be configured to insert, based on the driver command being associated with the distinct visible event type, a distinct visible token into a visibility stream. The at least one processor may be configured to decode the distinct visible token during a bin-render pass. The at least one processor may be configured to retrieve an entry from a table based on the distinct visible token, where the entry indicates a distinct execute command.

In some aspects, the techniques described herein relate to a method of graphics processing, including: inserting a driver command into a set of draw calls included in a binning pass, where the driver command is associated with a distinct visible event type; inserting, based on the driver command being associated with the distinct visible event type, a distinct visible token into a visibility stream; decoding the distinct visible token during a bin-render pass; and retrieving an entry from a table based on the distinct visible token, where the entry indicates a distinct execute command.

In some aspects, the techniques described herein relate to a method, where inserting the distinct visible token into the visibility stream includes: encoding, via a visibility stream coder (VSC), the distinct visible token into the visibility stream.

In some aspects, the techniques described herein relate to a method, where decoding the distinct visible token during the bin-render pass includes: decoding, via a visibility stream decoder (VSD), the distinct visible token from the visibility stream.

In some aspects, the techniques described herein relate to a method, where retrieving the entry from the table based on the distinct visible token includes: fetching, via a command processor (CP), a slice of the table.

In some aspects, the techniques described herein relate to a method, where the slice includes a Z-pass-done event.

In some aspects, the techniques described herein relate to a method, where the table includes a fixed stride draw table (FSDT).

In some aspects, the techniques described herein relate to a method, further including: executing, via a graphics processor unit (GPU), the distinct execute command after the retrieval of the entry.

In some aspects, the techniques described herein relate to a method, further including: outputting, via a command processor (CP), the distinct execute command to a primitive controller (PC) after the retrieval of the entry.

In some aspects, the techniques described herein relate to a method, where the distinct execute command includes a command to write an occlusion count (OC) to a memory.

In some aspects, the techniques described herein relate to a method, where the distinct visible event type is associated with an always-visible command and a visible primitive.

In some aspects, the techniques described herein relate to a method, where the distinct visible event type is not associated with an invisible primitive.

In some aspects, the techniques described herein relate to a method, where a fixed stride draw table (FSDT) includes the set of draw calls and a set of associated event types, where the set of associated event types includes the distinct visible event type and a distinct invisible event type.

In some aspects, the techniques described herein relate to a method, where a draw call of the set of draw calls is associated with the distinct visible event type, further including: inserting, based on the draw call being associated with the distinct visible event type, a second distinct visible token into the visibility stream; decoding the second distinct visible token during the bin-render pass; and retrieving the draw call from the table based on the decoded second distinct visible token.

In some aspects, the techniques described herein relate to a method, further including: rendering, via a graphics processor unit (GPU), the retrieved draw call for a bin associated with the decoded second distinct visible token.

In some aspects, the techniques described herein relate to a method, where a draw call of the set of draw calls is associated with the distinct invisible event type, further including: inserting, based on the draw call being associated with the distinct invisible event type, a distinct invisible token into the visibility stream; decoding the distinct invisible token during the bin-render pass; and refraining from retrieving the draw call from the table based on the decoded distinct invisible token.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system, in accordance with one or more techniques of this disclosure.

FIG. 2 illustrates an example GPU, in accordance with one or more techniques of this disclosure.

FIG. 3 illustrates an example image or surface, in accordance with one or more techniques of this disclosure.

FIG. 4A illustrates an example of a command stream having a set of executable commands and a set of draw tables, in accordance with one or more techniques of this disclosure.

FIG. 4B illustrates an example of a command stream having a draw table that includes indicators of executable commands, in accordance with one or more techniques of this disclosure.

FIG. 5 illustrates an example of a token that may be used for a visibility stream, in accordance with one or more techniques of this disclosure.

FIG. 6 is a call flow diagram illustrating example communications between a CPU and a GPU in accordance with one or more techniques of this disclosure.

FIG. 7 is a flowchart of an example method of graphics processing, in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some examples, a graphics processor may insert a driver command into a set of draw calls included in a binning pass. A driver command may be a command obtained from a driver (e.g., a GPU driver) to perform work at a graphics processor, for example a draw command (i.e., to render an object on a display), a kernel command (i.e., to perform a computation), or an event command (i.e., to execute a command with an output, such as an occlusion count that is written out). A set of draw calls may include draw commands to draw a rendered object on a display. A binning pass may be a process by the GPU to divide a frame or a dataset into a set of tiles, or bins, in which primitives may be rendered into per-tile visibility information. The driver command inserted into the set of draw calls may be associated with a distinct visible event type or a distinct invisible event type. The distinct visible event type may be an identifier for a driver command that indicates that the driver command should be processed during a bin-render pass. For example, the distinct invisible event type may indicate the existence of a visible primitive for a bin, which may trigger rendering a primitive in the bin via a draw call. In another example, the distinct invisible event type may indicate the existence of an always-visible command, such as an occlusion count write out. In some aspects, such always-visible commands are always executed during a bin-render pass. The distinct invisible event type may be an identifier for a driver command that indicates that the driver command is a draw call for an invisible primitive in a bin (i.e., the primitive may not be visible as it may be behind another rendered primitive, or may not have visible boundaries that extend into the bin). The graphics processor may insert, based on the driver command being associated with the distinct visible event type, a distinct visible token into a visibility stream. A distinct visible token may be a token that indicates whether a driver command is associated with a distinct visible event type. A visibility stream may be a stream of tokens that indicates whether a set of driver commands should be processed (e.g., an always-visible command, a visible primitive) or not be processed (e.g., an invisible primitive). The graphics processor may decode the distinct visible token during a bin-render pass. A bin-render pass may be a process by the GPU to render primitives for a set of bins. During the bin-render pass, the GPU may execute other driver commands, such as kernel commands or event commands. The graphics processor may retrieve an entry from a table (e.g., a fixed stride draw table (FSDT)) based on the distinct visible token. The entry may indicate a distinct execute command. A distinct execute command may be a command that is always executed by a graphics processor, for example an occlusion query that writes out an occlusion count. The graphics processor may execute the distinct execute command after the retrieval of the entry.

In some aspects, a graphics processor may define an event as “always visible” for an FSDT. An FSDT may be a table defined in an indirect buffer that optimizes state-fetching in a bin-render pass by indicating which primitives in a bin are visible or invisible. Each slice of an FSDT corresponding to a draw call may include exactly one draw call, while each slice of an FSDT corresponding to an execute command may include an indicator of an always-execute command, such as a kernel command or an event command. The driver of the graphics processor may be configured to put an “always-visible” event into a special FSDT slice in a bin visibility (BV) pass, which may also be referred to as a binning pass. Such a special slice may not include any draw calls. The command processor (CP) may be configured to send an “always-visible” event to the primitive controller (PC) and on to a visibility stream coder (VSC). The VSC may encode the portion of the visibility stream corresponding with the “always visible” event with a distinct visible event type, which may not be associated with a draw, but rather may be associated with a distinct visible token that is created. In other words, the distinct visible token may indicate a visible draw or may indicate the “always invisible” event. In the bin rendering (BR) pass, also referred to as a bin-render pass, the CP may be configured to always fetch the special FSDT slice independent of the visibility of other draws. The CP may fetch the special FSDT slide via a uCode or a prefetch engine, such as an FSDT fetch engine (FFE). The special FSDT slice may include, for example, pass-done events to support occlusion queries.

Particular aspects of the subject matter described in this disclosure can be implemented to realize one or more of the following potential advantages. In some examples, by inserting distinct visible tokens for both always-visible commands and for visible primitives for draw calls, the described techniques can be used to reduce overhead for driver commands that include both draw calls and kernel/event commands. The described techniques may also be used to conveniently insert commands that will always be executed for each bin for a bin-render pass.

For example, when a graphics processor tiles a frame (i.e., breaks the frame into a set of smaller bins), the graphics processor may run a set of driver commands several times. The graphics processor may execute a first set of driver commands in a binning pass to create a visibility stream. The graphics processor may then execute a second set of driver commands in a bin-render pass for each bin, each time consuming a copy of the visibility stream. The same set of driver commands, particularly the same set of draws, may be run in the binning pass and the bin-render pass. The graphics processor may enumerate the draw calls, for example from 1 to 100, and may us these enumerated values to index slices in an FSDT table. A visibility stream may indicate which draw calls have visible primitives in a designated bin, and which draw calls have invisible primitives in a designated bin. If the graphics processor wants to execute an always-execute command, for example writing out an occlusion count, after draw call #50 of a bin, the graphics processor may insert the new event as a pseudo-draw call #51 in the FSDT table and bump the other draw calls to be enumerated from 51-101. Some of the draw calls may be dropped in one or more bins, but the always-visible event may always be visible in all bins, ensuring that the FSDT slice 51 is always fetched and executed in all bins during the bin-render pass.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

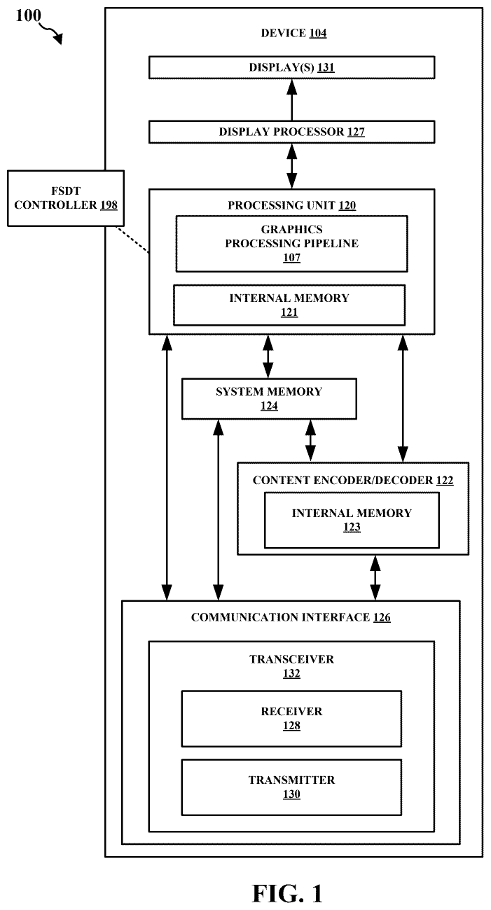

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, processing unit 120 may include an FSDT controller 198 configured to insert a driver command into a set of draw calls included in a binning pass. The driver command may be associated with a distinct visible event type. The FSDT controller 198 may be configured to insert, based on the driver command being associated with the distinct visible event type, a distinct visible token into a visibility stream. The FSDT controller 198 may be configured to decode the distinct visible token during a bin-render pass. The FSDT controller 198 may be configured to retrieve an entry from a table based on the distinct visible token, wherein the entry indicates a distinct execute command. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

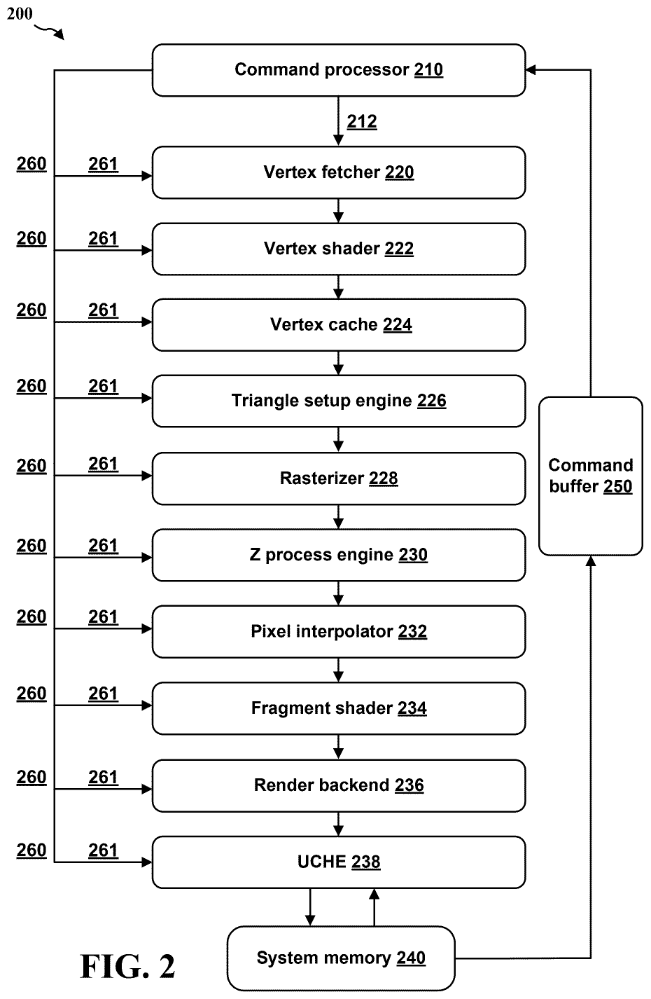

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections, tiles, or bins. After the division of the image, each section or tile can be rendered separately. Tiled rendering GPUs can divide computer graphics images into a grid format, such that each portion of the grid, i.e., a tile or a bin, is separately rendered. In some aspects of tiled rendering, during a binning pass or a BV pass, an image can be divided into different bins or tiles. In some aspects, during the binning pass, a GPU may construct a visibility stream where visible primitives or draw calls can be identified. The visibility stream may indicate which primitives in a bin are visible and which primitives in a bin are invisible. A rendering pass or a BR pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or BV pass and a rendering or BR pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. The GPU may identify, or mark, the visibility of a primitive in a visibility stream using a token. For example, a visibility stream may have a visible token associated with a primitive and a bin to indicate the visibility of the primitive in the bin, and may have an invisible token associated with a primitive and a bin to indicate that the primitive in the bin is not visible. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

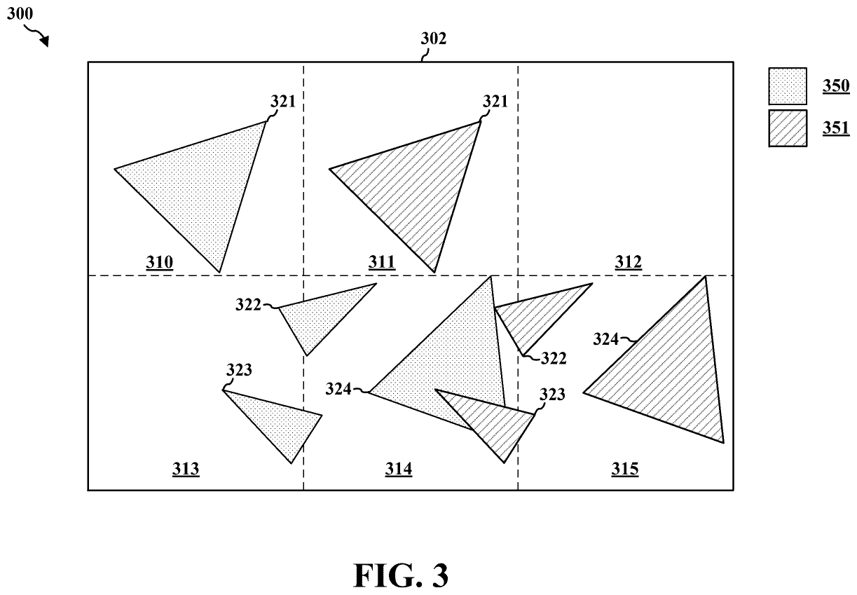

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

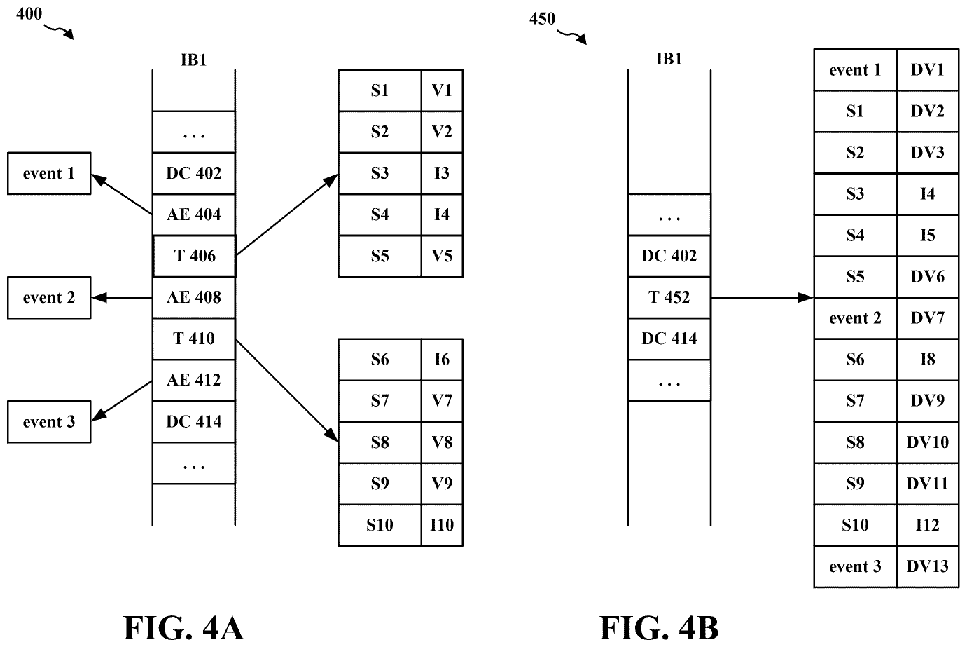

FIG. 4A is a diagram of a command stream 400 of a set of driver commands. The driver commands may include both executable commands and draw tables used to optimize state-fetching in a bin-render pass. The command stream 400 may include an indirect buffer (IB), designated as IB1. IB1 may include a set of driver commands. The set of driver commands of IB1 may include a driver command (DC) 402, an always-execute command (AE) 404, a table (T) 406, an AE 408, a T 410, an AE 412, and a DC 414. The DC 402 and the DC 414 may be driver commands, for example a type 4 command or a no operation (NOP) command. The T 406 and the T 410 may be tables configured to optimize state-fetching in a bin-render pass. The T 406 and the T 410 may be FSDTs having a plurality of entries, where each slice has a single draw call. A command processor (CP) may fetch a slice of such a table for visible draws. In some aspects, a driver may encode a visibility stream with tokens that indicate whether a slice has a draw call with a visible primitive or a draw call with an invisible primitive (e.g., the primitive is hidden behind another object). For example, T 406 may include five slices designated as S1, S2, S3, S4, and S5. Each slice may include a set of driver commands, where each set of driver commands in a slice has just one draw call. For example, S1 may include a SET_DRAW_STATE (SDS) command, followed by a Type 4 command, followed by a draw call command, followed by an NOP command. Similarly, S2 may include an SDS command, followed by an SDS command, followed by a draw call, followed by an NOP. During a binning pass, a driver may encode tokens for each slice in a bin-a visible token for a visible primitive and an invisible token for an invisible primitive. For example, the driver may determine that S1, S2, and S5 have visible primitives, and S3 and S4 have invisible primitives. The driver may encode visible tokens for S1, S2, and S5, shown in FIG. 4A as V1, V2, and V5, respectively, and may encode invisible tokens for S3 and S4, shown in FIG. 4A as I3 and I4, respectively. In another example, T 410 may include five slices designated as S6, S7, S8, S9, and S10. Each slice may include a set of driver commands, where each set of driver commands in a slice has just one draw call. For example, S8 may include an SDS command, followed by a Type 4 command, followed by another Type 4 command, followed by a draw call command. Similarly, S9 may include a Type 4 command, followed by a draw call command, followed by an NOP. During a binning pass, a driver may encode tokens for each slice in a bin-a visible token for a visible primitive and an invisible token for an invisible primitive. For example, the driver may determine that S7, S8, and S9 have visible primitives, and S6 and S10 have invisible primitives. The driver may encode visible tokens for S7, S8, and S9, shown in FIG. 4A as V7, V8, and V9, respectively, and may encode invisible tokens for S6 and S10, shown in FIG. 4A as I6 and I10, respectively. The visibility stream may be used to optimize state-fetching in a bin-render pass. For example, a CP may be configured to fetch (e.g., via uCode or an FFE) slices associated with visible tokens, and may refrain from fetching slices associated with invisible tokens.

AE 404, AE 408, and AE 412 may be executable driver commands that are configured to always execute. Such commands may include, for example, occlusion count (OC) commands where a GPU writes out a number of occlusions. AE 404 is shown as having a driver command designated as event 1. AE 408 is shown as having a driver command designated as event 2. AE 412 is shown as having a driver command designated as event 3. Such executable driver commands may not be included in a table. In other words, T 406 and T 410 may not be configured to include executable driver commands in the table. As a result, a driver may break up tables and use a different IB (e.g., designated as IB2) to execute AE 404, AE 408, and AE 412.

A CP executing the driver commands of IB1 may first execute DC 402 (e.g., Type 4), then execute AE 404 (i.e., event 1), then process T 406 by encoding a visibility stream and fetching S1, S2, and S5, then stop processing T 406 to execute AE 408 (i.e., event 2), then process T 410 by encoding a visibility stream and fetching S7, S8, and S9, then stop processing T10 to execute AE 412 (i.e., event 3), then execute DC 414 (e.g., Type 4). Breaking up T 406 and T 410 may increase the overhead of processing driver commands, as it would be faster to process S1 to S10 all in a single FSDT (i.e., a single binning pass followed by a single bin-render pass) than to process T 406, then stop processing T 406 to execute AE 408, then processing T 410 (i.e., two binning passes and two bin-render passes).

FIG. 4B is a diagram of a command stream 450 of the same set of driver commands in FIG. 4A. However, a table, designated as T 452, may be configured to include slices with a draw call and slices with an executable driver command. The set of driver commands of IB1 may also include DC 402 and DC 414, which may be driver commands such as Type 4 commands or NOP commands. T 452 may include slices with a single draw call, such as S1 to S10. T 452 may include slices with executable driver commands, such as event 1, event 2, and event 3.

During a binning pass, a driver may encode tokens for each slice in a bin in a visibility stream—a distinct visible token for a visible primitive or an executable driver command (e.g., an always-visible command) and a distinct invisible token for an invisible primitive. In other words, the distinct visible token may be associated with a table slice having a single draw call, and may be associated with an executable driver command. For example, the driver may determine that event 1, event 2, and event 3 are executable driver commands, or always-visible commands, may determine that S1, S2, S5, S7, S8, and S9 have visible primitives, and S3, S4, S6, and S10 have invisible primitives. An always-visible command may be a driver command that is always-visible and is independent of another draws' visibility. The driver may encode distinct visible tokens for event 1, S1, S2, S5, event 2, S7, S8, S9, and event 3, shown in FIG. 4B as DV1, DV2, DV3, DV6, DV7, DV9, DV10, DV11, and DV13, and may encode invisible tokens for S3, S4, S6, and S10, shown in FIG. 4B as I4, I5, I8, and I12. A CP may send the event to a PC, and on to a VSC. The VSC may encode the visibility stream with distinct visible tokens.

The visibility stream may be used to optimize state-fetching in a bin-render pass. For example, a CP may be configured to fetch (e.g., via uCode or an FFE) slices associated with distinct visible tokens, and may refrain from fetching slices associated with invisible tokens. In other words, the CP may always fetch always-visible commands, as such commands are always associated with a distinct visible token. The primitive controller (PC) may ignore such distinct visible tokens. The slice for event 1, event 2, and event 3 may include indicators of executable driver commands, such as a Z-pass-done event to support occlusion queries. A Z-pass-done event may be a command for a GPU to write out a counter of visible pixels. A GPU driver may be configured to periodically issue Z-pass done events to collect statistics about what the GPU draws.

In some aspects, during the binning pass, the driver of a GPU may issue an “always execute” command to the CP. In response to receiving the “always execute” command from the driver, the CP may generate an “always execute” event. The CP may transmit the “always execute” event to the PC, along with other commands, such as visible draw commands. The PC may forward the “always execute” events and draw commands to a VSC, which then encodes an “always visible” token, also referred to as a distinct visible token, for any “always execute” commands and visible draw commands in the visibility stream.

In some aspects, during the render pass, the driver of a GPU may read the visibility stream encoded by the VSC. The driver may read the visibility stream using a VSD. Both the CP and the PC may read the visibility stream. In response to reading an “always visible” token, or a distinct visible token, the CP may fetch an FSDT slice. In response to reading a distinct visible token, the PC may not take any action if the token is associated with an “always execute” command, also referred to as a distinct execute command, or may optimize its fetching of related draw information if the token is associated with a visible draw/primitive. In other words, the PC may “discard” distinct visible tokens that are associated with distinct execute commands, and may use the distinct visible token as a trigger to optimize fetching of related draw information when they are associated with a visible draw/primitive.

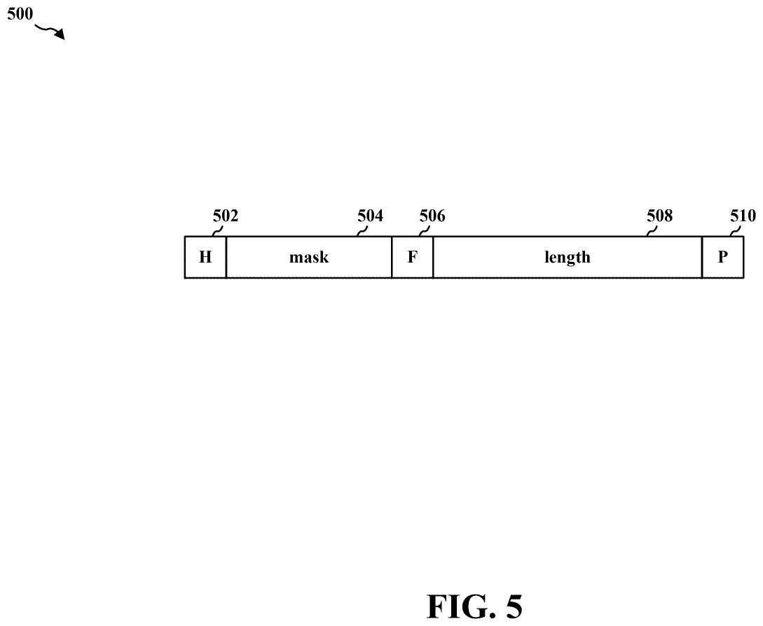

FIG. 5 is a diagram of a token format 500 having a header 502, a mask 504, a flag 506, a length 508, and a parity 510. The token length may be 67 bits. The token format 500 may be used by a VSC encoding tokens for a visibility stream. The header 502 may indicate whether the token is associated with a visible primitive, an invisible primitive, or an always-visible command. For example, the header 502 may be a 0 for a slice having a draw call associated with an invisible primitive for a bin, a 1 for a slice having a draw call associated with a visible primitive for a bin, or a 1 for a slice having an indicator of an always-visible command. The mask 504 may indicate in which bins the draw call is visible. The flag 506 may indicate whether a draw call is instanced for a token associated with a slice with a draw call, and may indicate whether an always-visible command has an overflow, does not have an overflow, or is associated with a CP-Draw for a token associated with a slice with an always-visible command. If the header 502 is 0 or the mask does not equal 0, the flag may be one bit. If the header is 1 and the mask equals zero, the flag may be two bits. The length 508 may indicate a number of invisible draws for a slice associated with an invisible primitive, may indicate a primitive span length for a slice associated with a visible primitive, and may be a series of 0 bits for a slice associated with an always-visible command. The length 508 may be variable in length, and may be encoded with Elias-gamma coding. Below, Table 1 indicates a possible use for the token format 500 shown in FIG. 5.

TABLE 1

| Meaning | Header | Mask | Flag | Length | Comments |
|---|---|---|---|---|---|
| Invisible | 0 | None | 1 = instanced | Number of | |
| | | | | invisible draws | |
| Visible | 1 | In which bins | 1 = instanced | Primitive span | |
| | | | | length | |
| EOS | 1 | =0 | 01 = Overflow | =16′b0 | End of Stream |
| EOS | | | 00 = No overflow | | End of Stream |
| CP-Draw | | | 10 = Visible Draw | | Visible Draw: |
| | | | 11 = Reserved | | all bins |
| EOL | 1 | =0 | 0x | ≠0 | End of Line |
| EOL | 1 | =0 | 10 | ≠0 | =Invisible, |
| | | | | | F = 0, length = 1 |
| EOL | 1 | =0 | 11 | ≠0 | =Invisible, |
| | | | | | F = 1, length = 1 |

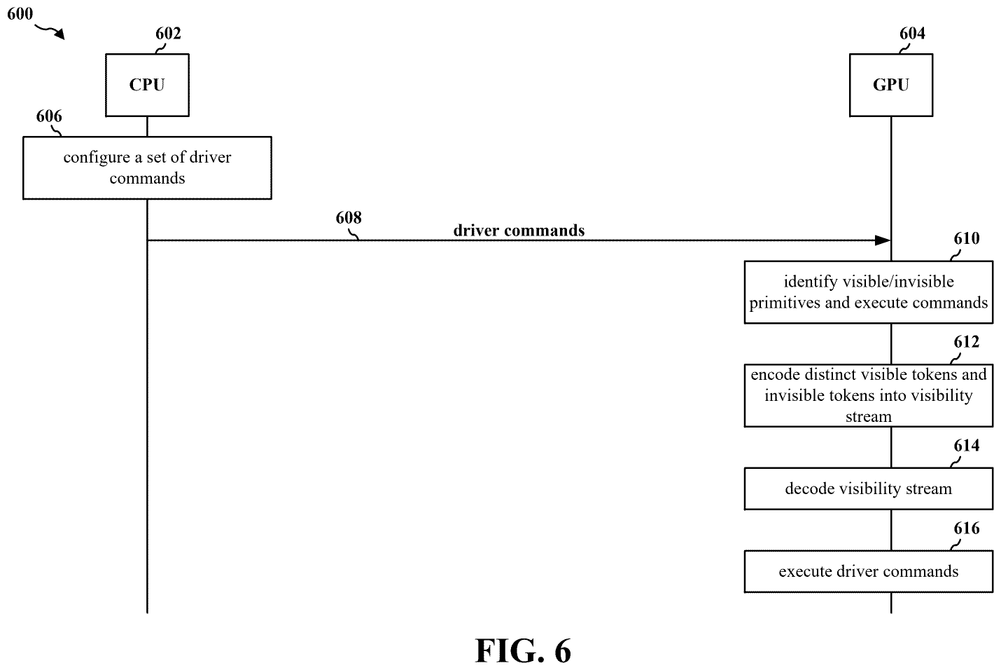

FIG. 6 is a call flow diagram 600 illustrating example communications between a CPU 602 and a GPU 604. The CPU 602 may include a processor of a system configured to transmit driver commands to the GPU 604. The GPU 604 may include the driver, the CP, the PC, the VSC, and the visibility stream decoder (VSD) of the GPU.

At 606, the CPU 602 may configure a set of driver commands for the GPU 604. The set of driver commands may include, for example, draw calls, kernel commands, and/or event commands. The CPU 602 may transmit a set of driver commands 608 to the GPU 604. The GPU 604 may receive the set of driver commands 608 from the CPU 602. The GPU 604 may receive the set of driver commands 608 via a driver at a device.

At 610, the GPU 604 may perform a binning pass to identify which of the set of driver commands are associated with invisible primitives, visible primitives (and which bins the visible primitives are associated with), and whether any of the set of driver commands are execute commands, or always-visible commands. At 612, the GPU 604 may encode distinct visible tokens into a visibility stream for driver commands that are associated with slices having draw calls with visible primitives, or driver commands that are always-visible commands. The GPU 604 may encode invisible tokens into the visibility stream for driver commands that are associated with slices having draw calls with invisible primitives. The driver of the GPU 604 may encode the slices having draw calls and slices that do not have draw calls into the same FSDT. The CP of the GPU 604 may send an event to a PC and on to a VSC, which may encode the visibility stream with distinct visible tokens and invisible tokens associated with the slices of the FSDT.

At 614, the GPU 604 may decode the visibility stream during a bin-render pass. The GPU may decode the visibility stream via a VSD. The CP of the GPU 604 may use uCode or FFE to fetch slices of the FSDT. The GPU 604 may select slices to fetch based on whether the slice is associated with a distinct visible token. The slice may include a draw call, or may include a distinct execute command. At 616, the GPU 604 may execute driver commands, for example Z-pass-done events to support occlusion queries, and may render visible primitives for slices with draw calls associated with the distinct visible tokens.

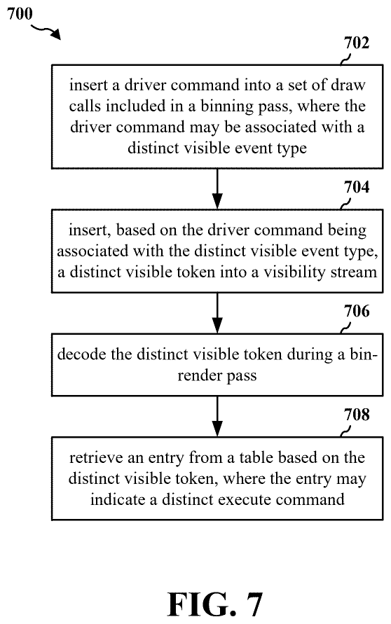

FIG. 7 is a flowchart 700 of an example method of graphics processing in accordance with one or more techniques of this disclosure. The method may be performed by an apparatus, such as an apparatus for graphics processing, a GPU, a driver, a CP, a PC, a VSC, a VSD, a CPU, as used in connection with the aspects of FIGS. 1-3, 4A, 4B, and 5-6.

At 702, the apparatus may insert a driver command into a set of draw calls included in a binning pass. The driver command may be associated with a distinct visible event type. For example, referring to FIG. 6, the GPU 604 may insert a driver command into a set of draw calls included in a binning pass. The driver command may be associated with a distinct visible event type. Moreover, the FSDT controller 198 in FIG. 1 may insert a driver command into a set of draw calls included in a binning pass. The driver command may be associated with a distinct visible event type.

At 704, the apparatus may insert, based on the driver command being associated with the distinct visible event type, a distinct visible token into a visibility stream. For example, referring to FIG. 6, the GPU 604 may insert, based on the driver command being associated with the distinct visible event type, a distinct visible token into a visibility stream. Moreover, the FSDT controller 198 in FIG. 1 may insert, based on the driver command being associated with the distinct visible event type, a distinct visible token into a visibility stream.

At 706, the apparatus may decode the distinct visible token during a bin-render pass. For example, referring to FIG. 6, the GPU 604 may decode the distinct visible token during a bin-render pass. Moreover, the FSDT controller 198 in FIG. 1 may decode the distinct visible token during a bin-render pass.

At 708, the apparatus may retrieve an entry from a table based on the distinct visible token, where the entry may indicate a distinct execute command. For example, referring to FIG. 6, the GPU 604 may retrieve an entry from a table based on the distinct visible token, where the entry may indicate a distinct execute command. Moreover, the FSDT controller 198 in FIG. 1 may retrieve an entry from a table based on the distinct visible token, where the entry may indicate a distinct execute command.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for inserting a driver command into a set of draw calls included in a binning pass. The driver command may be associated with a distinct visible event type. The apparatus may further include means for inserting, based on the driver command being associated with the distinct visible event type, a distinct visible token into a visibility stream. The apparatus may further include means for decoding the distinct visible token during a bin-render pass. The apparatus may further include means for retrieving an entry from a table based on the distinct visible token. The entry may indicate a distinct execute command. The apparatus may further include means for inserting the distinct visible token into the visibility stream by encoding, via a visibility stream coder (VSC), the distinct visible token into the visibility stream. The apparatus may further include means for decoding the distinct visible token during the bin-render pass by decoding, via a visibility stream decoder (VSD), the distinct visible token from the visibility stream. The apparatus may further include means for retrieving the entry from the table based on the distinct visible token by fetching, via a command processor (CP), a slice of the table. The slice may include a Z-pass-done event. The table may include a fixed stride draw table (FSDT). The apparatus may further include means for executing, via a graphics processor unit (GPU), the distinct execute command after the retrieval of the entry. The apparatus may further include means for outputting, via a CP, the distinct execute command to a primitive controller (PC) after the retrieval of the entry. The distinct execute command may include a command to write an occlusion count (OC) to a memory. The distinct visible event type may be associated with an always-visible command and a visible primitive. The distinct visible event type may not be associated with an invisible primitive. An FSDT may include the set of draw calls and a set of associated event types. The set of associated event types may include the distinct visible event type and a distinct invisible event type. A draw call of the set of draw calls may be associated with the distinct visible event type. The apparatus may further include means for inserting, based on the draw call being associated with the distinct visible event type, a second distinct visible token into the visibility stream. The apparatus may further include means for decoding the second distinct visible token during the bin-render pass. The apparatus may further include means for retrieving the draw call from the table based on the decoded second distinct visible token. The apparatus may further include means for rendering, via a GPU, the retrieved draw call for a bin associated with the decoded second distinct visible token. A draw call of the set of draw calls may be associated with the distinct invisible event type. The apparatus may further include means for inserting, based on the draw call being associated with the distinct visible event type, a distinct invisible token into the visibility stream. The apparatus may further include means for decoding the distinct invisible token during the bin-render pass. The apparatus may further include means for refraining from retrieving the draw call from the table based on the decoded distinct invisible token.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing, comprising: inserting a driver command into a set of draw calls included in a binning pass, wherein the driver command is associated with a distinct visible event type; inserting, based on the driver command being associated with the distinct visible event type, a distinct visible token into a visibility stream; decoding the distinct visible token during a bin-render pass; and retrieving an entry from a table based on the distinct visible token, wherein the entry indicates a distinct execute command.

Aspect 2 is the method of aspect 1, wherein inserting the distinct visible token into the visibility stream comprises: encoding, via a visibility stream coder (VSC), the distinct visible token into the visibility stream.

Aspect 3 is the method of either of aspects 1 or 2, wherein decoding the distinct visible token during the bin-render pass comprises: decoding, via a visibility stream decoder (VSD), the distinct visible token from the visibility stream.

Aspect 4 is the method of any of aspects 1 to 3, wherein retrieving the entry from the table based on the distinct visible token comprises: fetching, via a command processor (CP), a slice of the table.

Aspect 5 is the method of aspect 4, wherein the slice comprises a Z-pass-done event.

Aspect 6 is the method of either of aspects 4 or 5, wherein the table comprises a fixed stride draw table (FSDT).

Aspect 7 is the method of any of aspects 1 to 6, further comprising: executing, via a graphics processor unit (GPU), the distinct execute command after the retrieval of the entry.

Aspect 8 is the method of any of aspects 1 to 7, further comprising: outputting, via a command processor (CP), the distinct execute command to a primitive controller (PC) after the retrieval of the entry.

Aspect 9 is the method of any of aspects 1 to 8, wherein the distinct execute command comprises a command to write an occlusion count (OC) to a memory.

Aspect 10 is the method of any of aspects 1 to 9, wherein the distinct visible event type is associated with an always-visible command and a visible primitive.

Aspect 11 is the method of aspect 10, wherein the distinct visible event type is not associated with an invisible primitive.

Aspect 12 is the method of any of aspects 1 to 11, wherein a fixed stride draw table (FSDT) comprises the set of draw calls and a set of associated event types, wherein the set of associated event types comprises the distinct visible event type and a distinct invisible event type.

Aspect 13 is the method of aspect 12, wherein a draw call of the set of draw calls is associated with the distinct visible event type, further comprising: inserting, based on the draw call being associated with the distinct visible event type, a second distinct visible token into the visibility stream; decoding the second distinct visible token during the bin-render pass; and retrieving the draw call from the table based on the decoded second distinct visible token.

Aspect 14 is the method of aspect 13, further comprising: rendering, via a graphics processor unit (GPU), the retrieved draw call for a bin associated with the decoded second distinct visible token.

Aspect 15 is the method of any of aspects 12 to 14, wherein a draw call of the set of draw calls is associated with the distinct invisible event type, further comprising: inserting, based on the draw call being associated with the distinct visible event type, a distinct invisible token into the visibility stream; decoding the distinct invisible token during the bin-render pass; and refraining from retrieving the draw call from the table based on the decoded distinct invisible token.

Aspect 16 is an apparatus for graphics processing including at least one processor coupled to a memory and configured to implement a method as in any of aspects 1-15.

Aspect 17 may be combined with Aspect 16 and includes that the apparatus is a wireless communication device

Aspect 18 is an apparatus for graphics processing including means for implementing a method as in any of aspects 1-15.

Aspect 19 is a computer-readable medium (e.g., a non-transitory computer-readable medium) storing computer executable code, the code when executed by at least one processor causes the at least one processor to implement a method as in any of aspects 1-15.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
insert a driver command into a set of draw calls included in a binning pass, wherein the driver command is associated with a distinct visible event type;
insert, based on the driver command being associated with the distinct visible event type, a distinct visible token into a visibility stream;
decode the distinct visible token during a bin-render pass; and
retrieve an entry from a table based on the distinct visible token, wherein the entry indicates a distinct execute command.

2. The apparatus of claim 1, wherein, to insert the distinct visible token into the visibility stream, the processor is configured to:
encode, via a visibility stream coder (VSC), the distinct visible token into the visibility stream.

3. The apparatus of claim 1, wherein, to decode the distinct visible token during the bin-render pass, the processor is configured to:
decode, via a visibility stream decoder (VSD), the distinct visible token from the visibility stream.

4. The apparatus of claim 1, wherein, to retrieve the entry from the table based on the distinct visible token, the processor is configured to:
fetch, via a command processor (CP), a slice of the table.

5. The apparatus of claim 4, wherein the slice comprises a Z-pass-done event.

6. The apparatus of claim 4, wherein the table comprises a fixed stride draw table (FSDT).

7. The apparatus of claim 1, wherein the processor is further configured to:
execute, via a graphics processor unit (GPU), the distinct execute command after the retrieval of the entry.

8. The apparatus of claim 1, wherein the processor is further configured to:
output, via a command processor (CP), the distinct execute command to a primitive controller (PC) after the retrieval of the entry.

9. The apparatus of claim 1, wherein the distinct execute command comprises a command to write an occlusion count (OC) to the memory.

10. The apparatus of claim 1, wherein the distinct visible event type is associated with an always-visible command and a visible primitive.

11. The apparatus of claim 10, wherein the apparatus comprises a wireless communication device, wherein the distinct visible event type is not associated with an invisible primitive.

12. The apparatus of claim 1, wherein a fixed stride draw table (FSDT) comprises the set of draw calls and a set of associated event types, wherein the set of associated event types comprises the distinct visible event type and a distinct invisible event type.

13. The apparatus of claim 12, wherein a draw call of the set of draw calls is associated with the distinct visible event type, wherein the processor is further configured to:
insert, based on the draw call being associated with the distinct visible event type, a second distinct visible token into the visibility stream;
decode the second distinct visible token during the bin-render pass; and
retrieve the draw call from the table based on the decoded second distinct visible token.

14. The apparatus of claim 13, wherein the processor is further configured to:
render, via a graphics processor unit (GPU), the retrieved draw call for a bin associated with the decoded second distinct visible token.

15. The apparatus of claim 12, wherein a draw call of the set of draw calls is associated with the distinct invisible event type, wherein the processor is further configured to:
insert, based on the draw call being associated with the distinct invisible event type, a distinct invisible token into the visibility stream;
decode the distinct invisible token during the bin-render pass; and
refrain from retrieving the draw call from the table based on the decoded distinct invisible token.

16. A method of graphics processing, comprising:
inserting a driver command into a set of draw calls included in a binning pass, wherein the driver command is associated with a distinct visible event type;
inserting, based on the driver command being associated with the distinct visible event type, a distinct visible token into a visibility stream;
decoding the distinct visible token during a bin-render pass; and
retrieving an entry from a table based on the distinct visible token, wherein the entry indicates a distinct execute command.

17. The method of claim 16, wherein a fixed stride draw table (FSDT) comprises the set of draw calls and a set of associated event types, wherein the set of associated event types comprises the distinct visible event type and a distinct invisible event type.

18. The method of claim 17, wherein a draw call of the set of draw calls is associated with the distinct visible event type, further comprising:
inserting, based on the draw call being associated with the distinct visible event type, a second distinct visible token into the visibility stream;
decoding the second distinct visible token during the bin-render pass; and
retrieving the draw call from the table based on the decoded second distinct visible token.

19. The method of claim 17, wherein a draw call of the set of draw calls is associated with the distinct invisible event type, further comprising:
inserting, based on the draw call being associated with the distinct invisible event type, a distinct invisible token into the visibility stream;
decoding the distinct invisible token during the bin-render pass; and
refraining from retrieving the draw call from the table based on the decoded distinct invisible token.

20. A computer-readable medium storing computer executable code, the code when executed by a processor, causes the processor to:
insert a driver command into a set of draw calls included in a binning pass, wherein the driver command is associated with a distinct visible event type;
insert, based on the driver command being associated with the distinct visible event type, a distinct visible token into a visibility stream;
decode the distinct visible token during a bin-render pass; and
retrieve an entry from a table based on the distinct visible token, wherein the entry indicates a distinct execute command.
